(19) United States
(12) Patent Application Publication
(10) Pub. No.: US 2026/0067441 A1
(43) Pub. Date: Mar. 5, 2026

(54) CONFIGURATION METHOD FOR ENVIRONMENTAL CAMERA, ELECTRONIC DEVICE AND STORAGE MEDIUM

(71) Applicant: Beijing Zitiao Network Technology Co., Ltd., Beijing (CN)

(72) Inventors: Yuechuan Zhang, Beijing (CN); Junyuan Liu, Beijing (CN); Nongwei Lei, Beijing (CN); Xiaolong Wang, Beijing (CN); Ligang Li, Beijing (CN); Xiaofei Fang, Beijing (CN); Mingfei Song, Beijing (CN)

(21) Appl. No.: 19/317,019

(22) Filed: Sep. 2, 2025

(30) Foreign Application Priority Data
Sep. 2, 2024 (CN) 202411224437.3

(51) Int. Cl. H04N 13/293; H04N 13/296

(52) U.S. Cl. CPC H04N 13/293; H04N 13/296

(57) ABSTRACT

A configuration method for an environmental camera, an electronic device, and a storage medium are provided. The method includes: determining an optimal refresh rate value for a target application currently in operation; determining a target refresh rate value of the environmental camera based on the optimal refresh rate value of the target application currently in operation, wherein a difference between the target refresh rate value of the environmental camera and the optimal refresh rate value of the target application currently in operation is less than or equal to a first set threshold value; and configuring a refresh rate configuration item of the environmental camera using the target refresh rate value.

### CROSS-REFERENCE TO RELATED APPLICATION

This application claims priority to Chinese Patent Application No. 202411224437.3, filed on Sep. 2, 2024, the entire disclosure of which is incorporated herein by reference as part of the present disclosure.

### TECHNICAL FIELD

The present disclosure relates to the technical field of extended reality, and more particularly to a configuration method for an environmental camera, an electronic device, and a storage medium.

### BACKGROUND

Extended Reality (Extended Reality, XR) refers to the combination of real and virtual through computers to create a virtual environment capable of human-computer interaction. XR is also a general name for multiple technologies such as Virtual Reality (VR), Augmented Reality (AR) and Mixed Reality (MR). By integrating the visual interaction technologies of the three, the “immersion” of seamless transformation between the virtual world and the real world is brought to the experiencer. However, in the existing extended reality device, when the perspective function is in use, it often occurs that the real environment image presented is delayed. The frequent occurrence of this situation can lead to poor user experience.

### SUMMARY

The present disclosure provides a configuration method for an environmental camera, an electronic device, and a storage medium.

The present disclosure provides a configuration method for an environmental camera, the method is applicable to an extended reality device, and the method comprises: determining an optimal refresh rate value for a target application currently in operation; determining a target refresh rate value of the environmental camera based on the optimal refresh rate value of the target application currently in operation, wherein a difference between the target refresh rate value of the environmental camera and the optimal refresh rate value of the target application currently in operation is less than or equal to a first set threshold value; and configuring a refresh rate configuration item of the environmental camera using the target refresh rate value.

In at least one embodiment, the target refresh rate value of the environmental camera and the optimal refresh rate value of the target application currently in operation are equal.

In at least one embodiment, the determining a target refresh rate value of the environmental camera based on the optimal refresh rate value of the target application currently in operation comprises: determining whether the target application is a space camera application; determining the target refresh rate value of the environmental camera based on the optimal refresh rate value of the target application currently in operation in response to the target application being not a space camera application.

In at least one embodiment, the extended reality device includes a first operation mode, a second operation model and a third operation mode; in the first operation mode, an amount of resources occupied by a basic operation of a system of the extended reality device is a first resource amount; in the second operation mode, the amount of resources occupied by the basic operation of the system of the extended reality device is a second resource amount; in the third operation mode, the amount of resources occupied by the basic operation of the system of the extended reality device is a third resource amount; the first resource amount is greater than the second resource amount; the second resource amount is greater than or equal to the third resource amount; when an operation mode of the extended reality device is switched from the first operation mode to the second operation mode in operating a same application, an operation performance of the application in the extended reality device does not change; when the operation mode of the extended reality device is switched from the second operation mode to the third operation mode in operating a same application, the operation performance of the application in the extended reality device is degraded; and the determining a target refresh rate value of the environmental camera based on the optimal refresh rate value of the target application currently in operation comprises: determining the target refresh rate value of the environmental camera based on the optimal refresh rate value of the target application currently in an operational state when the extended reality device operates in the first operation mode.

In at least one embodiment, determining the target refresh rate value of the environmental camera based on the optimal refresh rate value of the target application currently in operation when the extended reality device operates in the first operation mode, comprises: determining the target refresh rate value of the environmental camera based on the optimal refresh rate value of the target application currently in operation when the extended reality device operates in the first operation mode and the optimal refresh rate value of the target application currently in operation is less than or equal to a set refresh rate threshold value.

In at least one embodiment, the method further comprises: determining the target refresh rate value of the environmental camera based on a refresh rate of a positioning tracking sensor in at least one of following cases: the extended reality device operating in the second operation mode; the extended reality device operating in the third operation mode; the target application being a space camera application; or the optimal refresh rate value of the target application currently in operation being greater than the set refresh rate threshold value.

The present disclosure further provides an electronic device, comprising: one or more processors; and a storage apparatus configured to store one or more programs, wherein the one or more programs, when executed by the one or more processors, cause the one or more processors to implement the above configuration method for an environmental camera.

The present disclosure further provides a non-transitory computer-readable storage medium, storing a computer program which, when executed by a processor, causes the above configuration method for an environmental camera to be implemented.

### BRIEF DESCRIPTION OF DRAWINGS

The accompanying drawings incorporated into the specification and constituting part of the specification illustrate the examples of the present disclosure, and serve, together with the specification, to explain the principles of the present disclosure.

In order to describe embodiments of the present disclosure more clearly, the accompanying drawings required for describing the embodiments will be described briefly below. Apparently, other accompanying drawings can also be derived from these drawings by those of ordinary skill in the art without creative efforts.

FIG. 1 is a flowchart of a configuration method for an environmental camera according to an embodiment of the present disclosure;

FIG. 2 is a schematic structural diagram of an environmental camera configuration device according to an embodiment of the present disclosure; and

FIG. 3 is a schematic structural diagram of an electronic device according to an embodiment of the present disclosure.

### DETAILED DESCRIPTION

In order to provide a clearer understanding of the objectives, features and advantages of the present disclosure, the solutions in the present disclosure will be further described below. It should be noted that the embodiments in the present disclosure and features in the embodiments may be combined with one another without conflict.

Many specific details are described below to help fully understand the present disclosure. However, the present disclosure may also be implemented in other manners different from those described herein. Apparently, the described examples are merely some rather than all of the examples of the present disclosure.

As in the background art, in the existing extended reality device, when the perspective function is in use, it often occurs that the presented real environment image is delayed. After thoroughly studying this phenomenon, the inventor believes that one reason for this phenomenon is that the refresh rate of the environmental camera used for photographing the environmental images is quite different from the screen refresh rate. For example, when the refresh rate of the environmental camera is lower than the screen refresh rate, the screen repeatedly displays old frame data that has been displayed while waiting for new frame data, thereby increasing the delay.

In view of this, the present application provides a configuration method for an environmental camera. The configuration method for an environmental camera is applicable to extended reality device.

Extended reality devices described in the present disclosure may include, but are not limited to, the following types: a computer-side extended reality device using a personal computer (PC) to perform related calculations and data output of extended reality functions, the external computer-side extended reality device using the data output by the PC to achieve the effect of extended reality; a mobile extended reality device supporting setting a mobile terminal (such as smartphones) in various ways (such as head-mounted display equipped with special card slots), and allowing the mobile terminal to perform related calculations on extended reality functions and output data to the mobile extended reality device through wired or wireless connections with mobile terminal, such as watching extended reality videos through applications of the mobile terminal; an all-in-one extended reality device having a processor for performing calculations related to virtual functions and therefore having independent extended reality input and output functions, with no need to be connected to a PC or mobile terminal, and having a high degree of usage freedom.

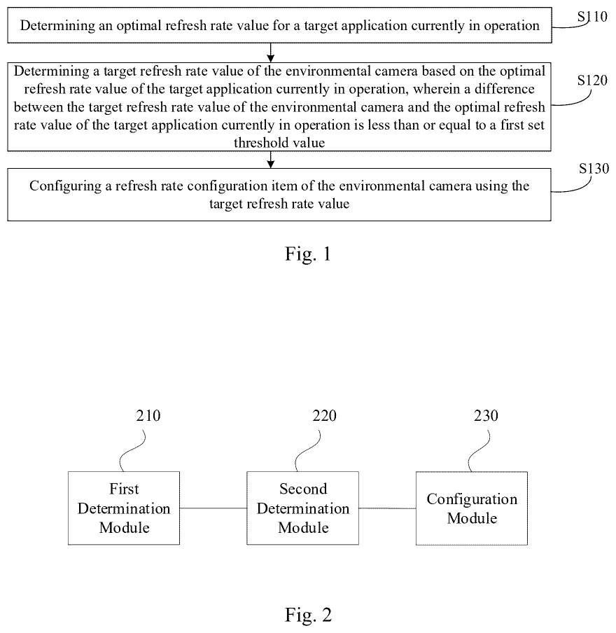

FIG. 1 is a flowchart of a configuration method for an environmental camera according to an embodiment of the present disclosure. Referring to FIG. 1, the method may specifically include following steps S110-S130.

S110: determining an optimal refresh rate value of a target application currently in operation.

The target application can be any application installed in the extended reality device, a built-in application in the system, or an external application in the system, that is, a third-party application.

The optimal refresh rate value of the target application is the refresh rate at which the target application achieves optimal operational performance. Optionally, the optimal refresh rate value of the target application is an ideal refresh rate set in the application development process according to the design goals and performance requirements.

S120, determining a target refresh rate value of the environmental camera based on the optimal refresh rate value of the target application currently in operation, wherein a difference between the target refresh rate value of the environmental camera and the optimal refresh rate value of the target application currently in operation is less than or equal to a first set threshold value.

When users start an extended reality device, the virtual space they enter is an extended reality space. An application panel may be displayed in the extended reality space, and the application panel may include icons of a plurality of applications. These applications may be 2D applications or 3D applications. Users can select one of the application icons in the application panel and trigger it. After triggering, the triggered application will be launched. The function of the extended reality space is similar to the function of a computer desktop. The extended reality space is created by the environmental image, and the environmental image resembles a desktop wallpaper.

In practice, the environmental image can be a virtual image or a real image. The virtual image is completely generated by the extended reality device, does not exist in the real world, and is used to build a purely virtual environment. The real image is an image of a physical world captured by an environmental camera.

When the environmental image is a real image, the environmental image is collected through an environmental camera. In this case, users can understand their real physical space through the environmental image, and virtual contents (such as application icons, application windows, virtual objects and virtual characters formed by the operation of applications, etc.) is superimposed on this environmental image.

The target refresh rate value of the environmental camera may be, for example, a refresh rate that the environmental camera is desired to use during operation.

The first set threshold value is a predetermined value, and the present disclosure does not limit the specific value. The difference between the target refresh rate value of the environment camera and the optimum refresh rate value of the target application currently in operation being less than or equal to the first set threshold value means that the target refresh rate value of the environment camera is very close to the optimum refresh rate value of the target application currently in operation.

The essence of this step is that the target refresh rate value of the environmental camera is configured according to the optimal refresh rate value of the target application currently in operation. In other words, the target refresh rate value of the environmental camera changes according to a change of the optimum refresh rate value of the target application currently in operation. The purpose of this change is to make the target refresh rate value of the environmental camera to be very close to the optimal refresh rate value of the target application currently in operation. In this way, the update paces of the environmental image and the virtual content tend to be consistent, shortening the duration of the screen waiting for new frame data when displaying the environmental image, and reducing the probability of repeatedly displaying the old frame data already displayed, thereby shortening or even eliminating the delay.

Optionally, the target refresh rate value of the environmental camera is the same as the optimal refresh rate value of the target application currently in operation. This means that the refresh rate of the environment camera and the application is exactly the same, and there will be no repeated display of old frame data. The changes in the surrounding objects in the image that users see through extended reality device are consistent with the changes in the real physical environment in which users are located.

S130: configuring a refresh rate configuration item of the environmental camera using the target refresh rate value.

In the above technical solution, through determining the optimal refresh rate value of the target application currently in operation; determining a target refresh rate value of the environmental camera based on the optimal refresh rate value of the target application currently in operation; a difference between a target refresh rate value of the environmental camera and an optimal refresh rate value of the target application currently in operation being less than or equal to a first set threshold value; and configuring a refresh rate configuration item of the environmental camera using the target refresh rate value, the target refresh rate value of the environment camera is close to the optimal refresh rate value of the currently running target application. This can shorten the duration of the screen waiting for new frame data, avoid the probability of repeated display of old frame data, and thus shorten or even eliminate the delay.

On the basis of the above technical solution, optionally, S120 may further include: determining whether the target application is a space camera application; determining the target refresh rate value of the environmental camera based on the optimal refresh rate value of the target application currently in operation in response to the target application being not a space camera application.

The space camera application may refer to, for example, an application that uses the environmental camera in the extended reality device to capture images of the user's environment. The focus of this type of application is to record environmental images, and usually does not involve displaying environmental images and target application pictures at the same time. Therefore, even if the target refresh rate value of the environmental camera is greatly different from the refresh rate of the space camera application, the visual experience of the user is not affected.

On the basis of the above technical solution, optionally, the extended reality device includes a first operation mode, a second operation model, and a third operation mode. In the first operation mode, an amount of resources occupied by a basic operation of a system of the extended reality device is a first resource amount; in the second operation mode, the amount of resources occupied by a basic operation of a system of the extended reality device is a second resource; in the third operation mode, the amount of resources occupied by a basic operation of a system of the extended reality device is a third resource. The first resource amount is greater than the second resource amount, and the second resource amount is greater than or equal to the third resource amount. Further, when the operation mode of the extended reality device is switched from the first operation mode to the second operation mode in the case of operating the same application, the operation performance of the application in the extended reality device is unchanged. When the operation mode of the extended reality device is switched from the second operation mode to the third operation mode in the case of operating the same application, the operation performance of the application in the extended reality device is degraded. S120 may include: determining the target refresh rate value of the environmental camera based on the optimal refresh rate value of the target application currently in an operational state when the extended reality device operates in the first operation mode.

There are systems and applications in the extended reality device. The system may refer to, for example, the operating system of extended reality device, which is responsible for managing hardware resources, providing user interface, and supporting the operation of the application. The application may be, for example, software running on the extended reality device that provides specific functions or services, such as games, educational software, social applications, etc.

In extended reality device, there is a close relationship between the system and application. The system provides the operating environment and support for the application, while the application uses the resources and services provided by the system to realize specific functions and services. Specifically, during the operation of the extended reality device, the system is responsible for allocating resources according to the needs of the application, such as CPU resources, GPU resources, internal memory space, etc. The system also controls the access permission of applications to device functions and resources through the permission management mechanism to ensure the security and stability of application. The system also provides a user interface framework for applications to help the applications interact effectively with users.

It should be noted that in practice, not only the operation of the application will occupy system resources (such as CPU resources, GPU resources, and internal memory space), but the operation of the system itself also needs to occupy system resources.

In the present application, the extended reality device may be operated in the first operation mode, the second operation mode, or the third operation mode.

The original design intention of the first operation mode is to ensure that the performance of both the system and the application is in a better state. In the first operation mode, the operation of the system and the application occupies more system resources. In the situation that the total system resource of the extended reality device is constant, the number of applications that can be operated is small when the extended reality device operates in the first operation mode. In other words, in the first operation mode, it is impossible to support multiple applications running simultaneously, and it is impossible to display multiple application windows at the same time.

The original design intention of the second operation mode is to sacrifice part of the system performance to ensure the performance of applications. In other words, when the extended reality device runs in the second operation mode, the performance of the applications is poor, but the performance of the system is better. Compared to the first operation mode, in the second operation mode, the resource occupied by the system operation is reduced. In the situation that the total system resources of the extended reality device are certain, more system resources can be reserved to support the operation of the application. This enables a greater number of applications to be supported to operate in the second operation mode as compared to the first operation mode. In other words, in the second operation mode, windows of a plurality of applications can be displayed simultaneously.

The third operation mode (in some scenarios, it can be called power-saving mode) is originally designed to sacrifice part of system performance and part of application performance to prolong the extended reality device's battery life duration. In other words, when the extended reality device is operating in the third operation mode, both the system performance and the application performance are inferior compared to the first operation mode. It should be emphasized that a prominent difference between the second operation mode and the third operation mode is whether or not the performance of the application is deteriorated.

The amount of resources occupied by the basic operation of the system of the extended reality device refers to the amount of resources (such as CPU resources, GPU resources, and internal memory space) occupied by the operation of the system itself without running applications.

The “sacrificing part of system performance” in the original design intention of the second operation mode is reflected in the fact that the amount of the first resource in the first operation mode is greater than the amount of the second resource in the second operation mode. In the original design intention of the second operation mode, “ensuring the performance of applications” is reflected in the fact that when the operation mode of the extended reality device is switched from the first operation mode to the second operation mode under the condition of running the same application, the operation performance of the application in the extended reality device remains unchanged.

Since the first resource amount in the first operation mode is greater than the second resource amount in the second operation mode, and the second resource amount in the second operation mode is greater than or equal to the third resource amount in the third operation mode, it means that the first resource amount in the first operation mode is greater than the third resource amount in the third operation mode. This is the embodiment of “sacrificing part of the system performance” in the original design intention of the third operation mode.

In the original design intention of the third operation mode, “sacrificing part of the performance of applications” is reflected in the fact that when the operation mode of the extended reality device is switched from the second operation mode to the third operation mode under the condition of running the same application, the operation performance of the applications in the extended reality device is degraded.

In general, the optimal refresh rate value of the target application currently in operation is relatively high and is generally higher than the refresh rate of the positioning tracking sensor, and the difference between the target refresh rate value of the environmental camera and the optimal refresh rate value of the target application currently in operation is less than or equal to the first set threshold value, which means that the refresh rate of the environmental camera is higher, which makes the performance of the environmental camera better. Therefore, the method is consistent with the original design intention of the first operation mode and contrary to the original design intention of the second operation mode and the third operation mode, and thus, whether or not the extended reality device operates in the first operation mode can be considered, to determine whether or not to determine the target refresh rate value of the environmental camera based on the optimal refresh rate value of the target application currently in operation.

On the basis of the above technical solution, S120 may be replaced by: determining the target refresh rate value of the environmental camera based on the optimal refresh rate value of the target application currently in operation in the situation that the extended reality device operates in the first operation mode and the optimal refresh rate value of the target application currently in operation is less than or equal to a set refresh rate threshold value.

If the optimum refresh rate value of the target application currently in operation is too large, it means that if the target refresh rate value of the environmental camera is determined to be close to the optimum refresh rate value, the power consumption of the extended reality device will be too large. In this way, the target refresh rate value of the environmental camera is determined based on the optimal refresh rate value of the target application currently in operation under the condition that the optimal refresh rate value of the target application currently in operation is less than or equal to the set refresh rate threshold value, which helps to seek a balance point between power consumption and performance of the perspective function.

On the basis of the above-described technical solutions, optionally, the target refresh rate value of the environmental camera can be determined based on the refresh rate of the positioning tracking sensor in at least one of the following situations: the extended reality device operating in the second operation mode; the extended reality device operating in the third operation mode; the target application being a space camera application; the optimal refresh rate value of the target application currently in operation being greater than the set refresh rate threshold value.

The positioning tracking sensor may be, for example, a sensor that locates the extended reality device and is responsible for tracking the head and body movements of the user to provide accurate position and orientation information. Exemplarily, the positioning tracking sensor may be a sensor with 6 degrees of freedom (DOF).

The target refresh rate value of the environmental camera is determined based on the refresh rate of the positioning tracking sensor; for example, the target refresh rate value of the environmental camera may be set to be consistent with the refresh rate of the positioning tracking sensor. In this way, image and motion information can be synchronized, and fused image and motion information can be efficiently connected, with less demand for computing resources.

It should be noted that the above-described method embodiments are described as a series of combinations of operations for simplicity of description, but those skilled in the art should recognize that the present disclosure is not limited by the described sequence of operations, because according to the present disclosure, some steps may be performed in other sequences or simultaneously. Secondly, those skilled in the art should also understand that the embodiments described in the specification are preferred embodiments, and the acts and modules involved are not necessary for the present disclosure.

FIG. 2 is a schematic structural diagram of an environmental camera configuration device according to an embodiment of the present disclosure. The environmental camera configuration device provided by the embodiment of the present disclosure may be configured in an extended reality device. Referring to FIG. 2, the environmental camera configuration device specifically includes: a first determination module 210, configured to determine an optimal refresh rate value of a target application currently in operation; a second determination module 220, configured to determine a target refresh rate value of the environmental camera based on the optimal refresh rate value of the target application currently in operation; and a configuration module 230, configured to configure a refresh rate configuration item of the environmental camera by using the target refresh rate value.

Further, the target refresh rate value of the environmental camera is the same as the optimal refresh rate value of the target application currently in operation.

Further, the second determination module 220 is configured to: determine whether the target application is a space camera application, and determine the target refresh rate value of the environmental camera based on the optimal refresh rate value of the target application currently in operation in response to the target application being not a space camera application.

Further, the extended reality device includes a first operation mode, a second operation model and a third operation mode; in the first operation mode, an amount of resources occupied by a basic operation of a system of the extended reality device is a first resource amount; in the second operation mode, an amount of resources occupied by the basic operation of the system of the extended reality device is a second resource amount; in the third operation mode, an amount of resources occupied by the basic operation of the system of the extended reality device is a third resource amount; the first resource amount is greater than the second resource amount; the second resource amount is greater than or equal to the third resource amount; when an operation mode of the extended reality device is switched from the first operation mode to the second operation mode in operating a same application, an operation performance of the application in the extended reality device does not change; when the operation mode of the extended reality device is switched from the second operation mode to the third operation mode in operating a same application, the operation performance of the application in the extended reality device is degraded; the second determination module 220 is configured to: determine the target refresh rate value of the environmental camera based on the optimal refresh rate value of the target application currently in an operational state when the extended reality device operates in the first operation mode.

The second determination module 220 is configured to: determine the target refresh rate value of the environmental camera based on the optimal refresh rate value of the target application currently in operation when the extended reality device operates in the first operation mode and the optimal refresh rate value of the target application currently in operation is less than or equal to a set refresh rate threshold value.

Further, the second determination module 220 is configured to: determine the target refresh rate value of the environmental camera based on a refresh rate of a positioning tracking sensor in at least one of following cases: the extended reality device operating in the second operation mode; the extended reality device operating in the third operation mode; the target application being a space camera application; or the optimal refresh rate value of the target application currently in operation being greater than the set refresh rate threshold value.

The environmental camera configuration device provided by the embodiment of the present disclosure can execute the steps in the configuration method for an environmental camera provided by the embodiment of the method of the present disclosure, and has execution steps and beneficial effects, and will not be repeatedly described herein.

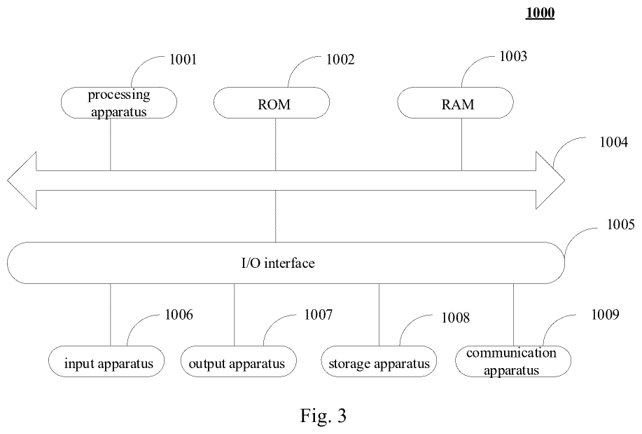

FIG. 3 illustrates a schematic structural diagram of an electronic device provided by an embodiment of the present disclosure. Referring to FIG. 3, FIG. 3 illustrates a schematic structural diagram of an electronic device 1000 suitable for implementing some embodiments of the present disclosure. The electronic device 1000 in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 3 is merely an example, and should not pose any limitation to the functions and the range of use of the embodiments of the present disclosure.

As illustrated in FIG. 3, the electronic device 1000 may include a processing apparatus 1001 (e.g., a central processing unit, a graphics processing unit, etc.), which can perform various suitable actions and processing according to a program stored in a read-only memory (ROM) 1002 or a program loaded from a storage apparatus 1008 into a random-access memory (RAM) 1003 to perform various actions and processing to realize the configuration method for an environmental camera provided by the embodiment of the present disclosure. The RAM 1003 further stores various programs and data required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatus may be connected to the I/O interface 1005: an input apparatus 1006 including, for example, a touch screen, a touch pad, a keyboard, a mouse, a camera, a microphone, an accelerometer, a gyroscope, or the like; an output apparatus 1007 including, for example, a liquid crystal display (LCD), a loudspeaker, a vibrator, or the like; a storage apparatus 1008 including, for example, a magnetic tape, a hard disk, or the like; and a communication apparatus 1009. The communication apparatus 1009 may allow the electronic device 1000 to be in wireless or wired communication with other devices to exchange data. While FIG. 3 illustrates the electronic device 1000 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1009 and installed, or may be installed from the storage apparatus 1008, or may be installed from the ROM 1002. When the computer program is executed by the processing apparatus 1001, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: determine an optimal refresh rate value for a target application currently in operation; determine a target refresh rate value of the environmental camera based on the optimal refresh rate value of the target application currently in operation, wherein a difference between the target refresh rate value of the environmental camera and the optimal refresh rate value of the target application currently in operation is less than or equal to a first set threshold value; and configure a refresh rate configuration item of the environmental camera using the target refresh rate value.

Optionally, when the above one or more programs are executed by the electronic device, the electronic device may be caused to execute other steps in the above embodiments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, the present disclosure provides an electronic device comprising: one or more processors, and a storage apparatus configured to store one or more programs, wherein the one or more programs, when executed by the one or more processors, cause the one or more processors to implement any one configuration method for an environmental camera provided by the present disclosure.

According to one or more embodiments of the present disclosure, the present disclosure provides a non-transitory computer-readable storage medium, storing a computer program which, when executed by a processor, causes any one configuration method for an environmental camera provided by the present disclosure to be implemented.

An embodiment of the present disclosure further provides a computer program product, including a computer program/instructions which, when executed by a processor, cause/causes the configuration method for an environmental camera described in the embodiments of the present disclosure to be implemented.

It should be noted that relational terms herein such as “first” and “second” are merely used to distinguish one entity or operation from another entity or operation without necessarily requiring or implying any actual such relationship or order between such entities or operations. In addition, terms “include”, “comprise”, or any other variations thereof are intended to cover a non-exclusive inclusion, so that a process, a method, an article, or a device including a series of elements not only includes those elements, but also includes other elements that are not explicitly listed, or also includes inherent elements of the process, the method, the article, or the device. Without more restrictions, the elements defined by the sentence “including a . . . ” do not exclude the existence of other equal elements in the process, method, article, or device including the elements.

The foregoing are descriptions of specific embodiments of the present disclosure, allowing a person skilled in the art to understand or implement the present disclosure. A plurality of amendments to are apparent to those skilled in the art, and general principles defined herein can be achieved in the other examples without departing from the spirit or scope of the present disclosure. Thus, the present disclosure will not be limited to these examples shown herein, but shall accord with the widest scope consistent with the principles and novel characteristics disclosed herein.

1. A configuration method for an environmental camera, wherein the configuration method is applicable to an extended reality device and comprises:
determining an optimal refresh rate value for a target application currently in operation;
determining a target refresh rate value of the environmental camera based on the optimal refresh rate value of the target application currently in operation, wherein a difference between the target refresh rate value of the environmental camera and the optimal refresh rate value of the target application currently in operation is less than or equal to a first set threshold value; and
configuring a refresh rate configuration item of the environmental camera using the target refresh rate value.

2. The configuration method according to claim 1, wherein the target refresh rate value of the environmental camera and the optimal refresh rate value of the target application currently in operation are equal.

3. The configuration method according to claim 1, wherein the determining a target refresh rate value of the environmental camera based on the optimal refresh rate value of the target application currently in operation comprises:
determining whether the target application is a space camera application;
determining the target refresh rate value of the environmental camera based on the optimal refresh rate value of the target application currently in operation in response to the target application being not a space camera application.

4. The configuration method according to claim 1, wherein the extended reality device includes a first operation mode, a second operation model and a third operation mode; in the first operation mode, an amount of resources occupied by a basic operation of a system of the extended reality device is a first resource amount; in the second operation mode, the amount of resources occupied by the basic operation of the system of the extended reality device is a second resource amount; in the third operation mode, the amount of resources occupied by the basic operation of the system of the extended reality device is a third resource amount; the first resource amount is greater than the second resource amount; the second resource amount is greater than or equal to the third resource amount;
when an operation mode of the extended reality device is switched from the first operation mode to the second operation mode in operating a same application, an operation performance of the application in the extended reality device does not change; when the operation mode of the extended reality device is switched from the second operation mode to the third operation mode in operating a same application, the operation performance of the application in the extended reality device is degraded; and
the determining a target refresh rate value of the environmental camera based on the optimal refresh rate value of the target application currently in operation comprises:
determining the target refresh rate value of the environmental camera based on the optimal refresh rate value of the target application currently in an operational state when the extended reality device operates in the first operation mode.

5. The configuration method according to claim 4, wherein the determining the target refresh rate value of the environmental camera based on the optimal refresh rate value of the target application currently in operation when the extended reality device operates in the first operation mode, comprises:
determining the target refresh rate value of the environmental camera based on the optimal refresh rate value of the target application currently in operation when the extended reality device operates in the first operation mode and the optimal refresh rate value of the target application currently in operation is less than or equal to a set refresh rate threshold value.

6. The configuration method according to claim 5, further comprising:
determining the target refresh rate value of the environmental camera based on a refresh rate of a positioning tracking sensor in at least one of following cases:
the extended reality device operating in the second operation mode;
the extended reality device operating in the third operation mode;
the target application being a space camera application; or
the optimal refresh rate value of the target application currently in operation being greater than the set refresh rate threshold value.

7. An electronic device comprising:
one or more processors;
a storage apparatus configured to store one or more programs;
wherein the one or more programs, when executed by the one or more processors, cause the one or more processors to implement a configuration method for an environmental camera, wherein the configuration method is applicable to an extended reality device and comprises:
determining an optimal refresh rate value for a target application currently in operation;
determining a target refresh rate value of the environmental camera based on the optimal refresh rate value of the target application currently in operation, wherein a difference between the target refresh rate value of the environmental camera and the optimal refresh rate value of the target application currently in operation is less than or equal to a first set threshold value; and
configuring a refresh rate configuration item of the environmental camera using the target refresh rate value.

8. The electronic device according to claim 7, wherein the target refresh rate value of the environmental camera and the optimal refresh rate value of the target application currently in operation are equal.

9. The electronic device according to claim 7, wherein the determining a target refresh rate value of the environmental camera based on the optimal refresh rate value of the target application currently in operation comprises:
determining whether the target application is a space camera application;
determining the target refresh rate value of the environmental camera based on the optimal refresh rate value of the target application currently in operation in response to the target application being not a space camera application.

10. The electronic device according to claim 7, wherein the extended reality device includes a first operation mode, a second operation model and a third operation mode; in the first operation mode, an amount of resources occupied by a basic operation of a system of the extended reality device is a first resource amount; in the second operation mode, the amount of resources occupied by the basic operation of the system of the extended reality device is a second resource amount; in the third operation mode, the amount of resources occupied by the basic operation of the system of the extended reality device is a third resource amount; the first resource amount is greater than the second resource amount; the second resource amount is greater than or equal to the third resource amount;
when an operation mode of the extended reality device is switched from the first operation mode to the second operation mode in operating a same application, an operation performance of the application in the extended reality device does not change; when the operation mode of the extended reality device is switched from the second operation mode to the third operation mode in operating a same application, the operation performance of the application in the extended reality device is degraded; and
the determining a target refresh rate value of the environmental camera based on the optimal refresh rate value of the target application currently in operation comprises:
determining the target refresh rate value of the environmental camera based on the optimal refresh rate value of the target application currently in an operational state when the extended reality device operates in the first operation mode.

11. The electronic device according to claim 10, wherein the determining the target refresh rate value of the environmental camera based on the optimal refresh rate value of the target application currently in operation when the extended reality device operates in the first operation mode, comprises:
determining the target refresh rate value of the environmental camera based on the optimal refresh rate value of the target application currently in operation when the extended reality device operates in the first operation mode and the optimal refresh rate value of the target application currently in operation is less than or equal to a set refresh rate threshold value.

12. The electronic device according to claim 11, wherein the method further comprises:
determining the target refresh rate value of the environmental camera based on a refresh rate of a positioning tracking sensor in at least one of following cases:
the extended reality device operating in the second operation mode;
the extended reality device operating in the third operation mode;
the target application being a space camera application; or
the optimal refresh rate value of the target application currently in operation being greater than the set refresh rate threshold value.

13. A non-transitory computer-readable storage medium storing a computer program which, when executed by a processor, causes a configuration method for an environmental camera to be implemented, wherein the configuration method is applicable to an extended reality device and comprises:
determining an optimal refresh rate value for a target application currently in operation;
determining a target refresh rate value of the environmental camera based on the optimal refresh rate value of the target application currently in operation, wherein a difference between the target refresh rate value of the environmental camera and the optimal refresh rate value of the target application currently in operation is less than or equal to a first set threshold value; and
configuring a refresh rate configuration item of the environmental camera using the target refresh rate value.

14. The non-transitory computer-readable storage medium according to claim 13, wherein the target refresh rate value of the environmental camera and the optimal refresh rate value of the target application currently in operation are equal.

15. The non-transitory computer-readable storage medium according to claim 13, wherein the determining a target refresh rate value of the environmental camera based on the optimal refresh rate value of the target application currently in operation comprises:
determining whether the target application is a space camera application;
determining the target refresh rate value of the environmental camera based on the optimal refresh rate value of the target application currently in operation in response to the target application being not a space camera application.

16. The non-transitory computer-readable storage medium according to claim 13, wherein the extended reality device includes a first operation mode, a second operation model and a third operation mode; in the first operation mode, an amount of resources occupied by a basic operation of a system of the extended reality device is a first resource amount; in the second operation mode, the amount of resources occupied by the basic operation of the system of the extended reality device is a second resource amount; in the third operation mode, the amount of resources occupied by the basic operation of the system of the extended reality device is a third resource amount; the first resource amount is greater than the second resource amount; the second resource amount is greater than or equal to the third resource amount;
when an operation mode of the extended reality device is switched from the first operation mode to the second operation mode in operating a same application, an operation performance of the application in the extended reality device does not change; when the operation mode of the extended reality device is switched from the second operation mode to the third operation mode in operating a same application, the operation performance of the application in the extended reality device is degraded; and
the determining a target refresh rate value of the environmental camera based on the optimal refresh rate value of the target application currently in operation comprises:
determining the target refresh rate value of the environmental camera based on the optimal refresh rate value of the target application currently in an operational state when the extended reality device operates in the first operation mode.

17. The non-transitory computer-readable storage medium according to claim 16, wherein the determining the target refresh rate value of the environmental camera based on the optimal refresh rate value of the target application currently in operation when the extended reality device operates in the first operation mode, comprises:
determining the target refresh rate value of the environmental camera based on the optimal refresh rate value of the target application currently in operation when the extended reality device operates in the first operation mode and the optimal refresh rate value of the target application currently in operation is less than or equal to a set refresh rate threshold value.

18. The non-transitory computer-readable storage medium according to claim 17, wherein the method further comprises:
determining the target refresh rate value of the environmental camera based on a refresh rate of a positioning tracking sensor in at least one of following cases:
the extended reality device operating in the second operation mode;
the extended reality device operating in the third operation mode;
the target application being a space camera application; or
the optimal refresh rate value of the target application currently in operation being greater than the set refresh rate threshold value.
